(19) United States
(12) Patent Application Publication
(10) Pub. No.: US 2008/0249863 A1
(43) Pub. Date: Oct. 9, 2008

(54) MANAGING A MULTI-FUNCTION SOCIAL NETWORK

(76) Inventor: Scott REDMOND, San Francisco, CA (US)

Correspondence Address: EVERGREEN VALLEY LAW GROUP, 2670 S. WHITE ROAD, SUITE 275, SAN JOSE, CA, 95148, US

(21) Appl. No.: 11/835,415

(22) Filed: Aug. 7, 2007

Related U.S. Application Data
(60) Provisional application No. 60/910,206, filed on Apr. 4, 2007.

(51) Int. Cl. G06Q 30/00; G06F 15/16

(52) U.S. Cl. 705/14; 705/1; 709/205

(57) ABSTRACT

Managing a multi-function social network. One or more communication devices are identified in various locations. Thereafter, activities on the one or more communication devices are captured. Based on the activities, data files are then provided independent of types of the one or more mobile communication devices, communication protocol and communication network providers associated with the one or more communication devices.

### BACKGROUND

1. Technical Field

Embodiments of the invention relate generally to social networks and more specifically to managing a multi-function social network.

2. Prior Art

A social network is a map of relationships between individuals, indicating ways in which they are connected through various social familiarities ranging from casual acquaintance to close familial bonds. Social networks exist independent of technology, for example, people network face-to-face, in public places, via mail, etc. Technology, particularly, e-mail, instant messenger (IM) and internet has made it easier and faster for people to maintain and nurture their immediate networks. The rise of social networking websites like Orkut®, MySpace®, Friendster®, Facebook©, etc., points to a need in society for such technological aid.

Friendster® is an internet social network service. Each user creates an online identity by filling out a questionnaire profile, and then defines a gallery of friends, and the service then integrates these galleries, allowing a user to search through a list of their friends or their friends' friends. MySpace® is a free service that uses the internet for online communication through an interactive network of photos, blogs, user profiles, e-mail, web forums, and groups, as well as other media formats. Orkut® is an internet social network service run by Google®. Orkut® helps users meet new friends and maintain existing relationships. Similar to Friendster®, Orkut® goes a step further by permitting “communities” of users. Orkut® is also an invitation-based operation. Users must be invited to join the community by someone who already has an account with Orkut®.

The popularity of sharing blogs and music, making friends, and dating over the internet has driven social networking beyond the Personal Computer (PC) to the mobile phone. The unparalleled potential of mobile phones and carrier networks to promote such connections in enhanced ways is now being fully recognized and exploited. What exists today are primarily Bluetooth based short range applications which allow interaction with ‘familiar strangers’ in the public space, web-based blogs and file sharing applications with a mobile component that allows users to send text messages to the service to essentially broadcast their location via text messaging to their friends, location-based instant messaging applications, interactive Wi-Fi applications that allow users to share their music locally through handheld devices, etc. These existing solutions ignore the nature of mobile phones as highly personal and intimate communication devices, using them instead as dumb portable internet terminals. As such, these portable versions of the same content miss some of the opportunity afforded by the “at-hand” nature of the device. For example, a camera phone provides the ability to capture spontaneous and intimate moments—experiences, not just photos—yet that significance is often lost when the results cannot be easily shared with people who understand the context.

Social networks can also offer a way to reach the targeted customers for advertising social media. As an example, consider the market potential of ‘North American Mothers’. This group represents a theoretical market in the neighborhood of $1 trillion by 2010. They account for 55 percent of consumer electronic spending; 51 percent of food spending; 49 percent of health and beauty spending; 48 percent of home furnishings spending; and 47 percent of apparel spending. While most new mothers are computer literate, they do not have time to sit at a computer terminal to browse the Internet. It will be advantageous if they can exchange pictures of their babies, provide breast-feeding tips, and arrange for swaps of baby clothes over a safe network with user preferences they control, all at the touch of button on their cell phone.

In today's world, finding and retaining customers has become very expensive. Research over years supports the idea that it is much more expensive to attract new customers than it is to retain customers. Hence, advertising in and through social networks is an emerging marketing trend. But, the market opportunities of social networks are not fully exploited by existing systems. Commercial entities wishing to advertise in a wireless social network must create different advertisements according to the different network provider's requirements. For example, currently, if Starbucks wants to reach the Friendster®, network on their cell phones, they must develop different advertisements for each type of cell phone and carrier, which is a highly difficult if not impossible task.

### SUMMARY

Embodiments of the invention described herein provide a method, system and computer program product for managing a multi-function social network.

An example method includes locating one or more communication devices. Thereafter, activities on the one or more communication devices are captured. Based on the activities, data files are then provided independent of types of the one or more communication devices, communication protocol and communication network providers associated with the one or more communication devices.

Another example method includes registering one or more commercial entities. Data files in one format independent of types of the one or more communication devices, communication protocol and communication network providers are then uploaded from the one or more commercial entities. Communication between a service provider and the one or more commercial entities is also enabled.

Yet another example method includes registering one or more customers. One or more homepages are then created for the one or more customers. Further, the one or more customers are grouped based on pre-determined criteria. One or more functions are also provided to the one or more customers. Thereafter, the one or more functions are performed in response to the inputs received from the one or more customers in real time. Based on the inputs reward points are also provided.

An example system includes a database, a customer module for enabling communication among one or more customers and a service provider, and a commercial entity module for enabling communication between one or more commercial entities and the service provider.

An example computer program product for managing a multi-function social network is provided. The computer program product includes a computer readable program code. The computer readable program code performs locating one or more communication devices. Thereafter, activities on the one or more communication devices are captured. Based on the activities, data files are then provided independent of types of the one or more communication devices, communication protocol and communication network providers associated with the one or more communication devices.

Other aspects and example embodiments are provided in the Figures and the Detailed Description that follow.

### BRIEF DESCRIPTION OF THE DRAWINGS

FIG. 1 is a flowchart illustrating a method for managing a multi-function social network in accordance with an embodiment of the invention;

FIG. 2 is a flowchart illustrating a method for managing a multi-function social network by one or more customers in accordance with an embodiment of the invention;

FIG. 3 is a schematic representation of a system in accordance with an embodiment of the invention;

FIG. 4 is a flowchart illustrating a method for uploading data files in a multi-function social network by one or more customers in accordance with an embodiment of the invention;

FIG. 5 is an exemplary graphical representation of a multi-function social network centered on a customer in accordance with an embodiment of the invention;

FIG. 6 is an exemplary representation illustrating how an external customer joins the multi-function social network in accordance with an embodiment of the invention;

FIG. 7 is an exemplary Graphical User Interface (GUI) in accordance with an embodiment of the invention; and

FIG. 8 is an exemplary Graphical User Interface (GUI) in accordance with another embodiment of the invention.

### DETAILED DESCRIPTION

Embodiments of the invention provide a method, system and computer program product for managing a multi-function social network. In an embodiment of the invention, managing includes creating the multi-function social network. The multi-function social network is explained using the example of one or more mobile phones, but it will be appreciated that the particular exemplary embodiment of the invention is provided by way of illustration and not a limitation. Embodiments of the invention may also be operated from one or more personal digital assistants (PDA), one or more web-appliances, one or more computers, one or more communication devices and the like. The method includes locating one or more mobile phones. Thereafter, activities on the one or more mobile phones are captured. Based on the activities, data files are then provided independent of type of the one or more mobile phones, communication protocol and communication network providers associated with the one or more mobile phones.

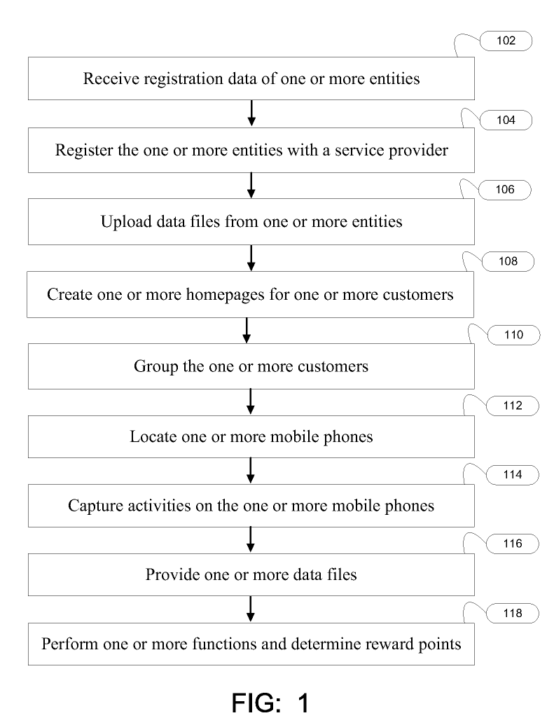

FIG. 1 is a flowchart illustrating a method for managing a multi-function social network in accordance with an embodiment of the invention. At step 102, registration data of one or more entities is received. Examples of the one or more entities include but are not limited to one or more customers and one or more commercial entities. The registration data of the one or more customers is received from one or more mobile phones. In an embodiment of the invention, the registration data of the one or more customers may include customer profile, type of mobile phone including manufacturer details, and communication network provider details.

In an embodiment of the invention, the registration data of the one or more commercial entities may include entity profile and type of entity.

At step 104, the one or more entities are registered with a service provider. In an embodiment of the invention, the registration data of the one or more entities may be validated and stored in database of the service provider.

In an embodiment of the invention, the one or more customers may register by sending a text. In another embodiment of the invention, the one or more customers may register by single key strokes on the one or more mobile phones dial pad.

In an embodiment of the invention, a contract may be defined for the one or more commercial entities.

In an embodiment of the invention, at step 106, the data files are uploaded from the one or more entities. In an embodiment of the invention, the data files may be uploaded in any format independent of types of the one or more mobile phones, communication protocol and communication network providers. For example, a single ad file may be uploaded from Starbucks® which may then be delivered to Ericsson® mobile using Hutchison® connection or Nokia® mobile using Airtel® connection.

At step 108, one or more home pages for the one or more customers are created in the database of the service provider. In an embodiment of the invention, at step 110, the one or more customers are grouped and the multi-social network is created. The grouping may be performed based on pre-determined criteria. Examples of pre-determined criteria include but are not limited to age, profession and interests. The one or more customers may interact with the members in the multi-social network through their mobile phones.

In an embodiment of the invention, the existing social networks of the one or more customers may be linked to the multi-function social network. A master web page may be optimized and used for viewing on the one or more mobile phones. In an embodiment of the invention, the master web page may be configured by having the one or more customers enter links to personal websites he or she has created on other social network sites like Linked-in, MySpace® and Orkut®. In another embodiment of the invention, the links to personal websites of the one or more customers may automatically be captured.

In an embodiment of the invention, the service provider captures data from each of the top social network links and merges or melts the data into a single page viewable on a handset. For example, Hypertext Markup Language (HTML) and images may be acquired from targeted pages and automatically edited into a single page which is displayed in the personal website page of a customer.

In an embodiment of the invention, the page data is the home pages for a specific user on each social network and the common page data is mirrored to the master page.

At step 112, one or more mobile phones are located. In an embodiment of the invention, a Global Location Resource (GLR) is used to find the location of the one or more mobile phones. The process uses a text-based GLR CODE™. For example, if a customer using a mobile phone is at or near the corner of Pine Street and Battery Street in San Francisco, the GLR code is ‘pin.bat.SF’. The standard protocol is the first three letters of one street followed by a dot and then the next three letters of the intersecting street followed by a dot and then the two letter city code of the city in which that particular intersection is located. It will be appreciated that any similar text-based code may be used within the spirit of the invention.

In an embodiment of the invention GLR code may be sent in response to a Short Message Service (SMS) or text message, or at any time to a certain SMS target address in order to solicit coupons or incentives for the neighborhood the customer is currently shopping or moving around in. In an embodiment of the invention, a three dimensional visualization tool may be provided to view the location of the customer in real time.

At step 114, activities on one or more mobile phones are captured. The activities of the one or more customers may be tracked through their mobile phones when they access voice mails, a website on the internet browser, through the SMS, and the like.

At step 116, one or more data files are provided to the one or more customers independent of types of the one or more mobile phones, communication protocol and communication network providers.

In an embodiment of the invention, an interface may be provided to enable communication between the communication network providers and the service provider. The interface helps to make the interaction independent of the communication network provider.

In an embodiment of the invention, an interface may be provided to enable communication between the communication network providers and the service provider. The interface helps to make the interaction independent of the communication network provider.

In an embodiment of the invention, an interface may be provided to enable communication between the one or more commercial entities and the service provider.

In an embodiment of the invention, the data files may be uploaded in any format which may then be delivered across various platforms independent of types of the one or more mobile phones, communication protocol and communication network providers. The data file may be sent as a multi-format dataset in various formats. Examples of various formats include but are not limited to SMS, Multimedia Message service (MMS), email, Voicemail, Hyper Text Transfer Protocol (HTTP), Extensible Markup Language (XML), and File Transfer Protocol (FTP). In an embodiment of the invention, a protocol that is passed to a mobile phone of a customer is logged to ID data of the customer. The protocol may be identified by using the response from the mobile phone. The response carries data which identifies which protocol was responded to, thus indicating which protocol is accepted.

In an embodiment of the invention, the service provider may store picture, fax, video, text and verbal information on voicemail box of the customer and download that data as sonic files to the mobile phone of the customer to be reassembled as the original data file. The reassembling may be performed using conversion software which converts the sound file into the data file. The conversion software may also be inbuilt in the software product operated by the service provider.

In an embodiment of the invention, the one or more commercial entities may select the group of target customers from the multi-function social network. The data files including the advertising contents may then be provided to the target customers. The advertising content is displayed on the mobile phones across multiple platforms. In an embodiment of the invention, this facility is provided by using a software platform operated by the service provider, for example, a Mobile Virtual Network Operator (MVNO). MVNO is a group that does not own a licensed frequency spectrum, but resells wireless services and other services with the ability to create a social network under their own brand name, using the network of another mobile phone operator. MVNO help mobile network operators to deliver specialized service requirements and enter into the customer niches.

In an embodiment of the invention, an extraction of data and results from legacy applications into new Web-based analytics is also performed. Web-based applications are created that place efficient graphics side-by-side with raw or processed data. Clicking on the visualization graphic may “drill down” on the data and reveal new table-based content or interactive graphics. Analysis may be performed using web-based analytics and the results may be delivered via the internet to the customers who may then define their own exploration into the underlying data. Different data formats are integrated to create single views of performance, exposure, markets or any other metrics.

In an embodiment of the invention, providing data files include providing one or more functions to the one or more customers. The one or more customers login to their homepages through their mobile phones to select the functions or to send inputs corresponding to the one or more functions to the service provider. Examples of the one or more functions include but are not limited to extending the multi-function social network by inviting other customers, publishing music play lists, uploading, downloading and sharing data files (photos and videos), posting blogs, joining other groups (clusters or communities), searching for customers and group-specific searching, posting public and group-specific messages, reading posted messages, and online trading. The one or more customers who are playing games using game boxes (Playstation 3®, Wii™, XBOX® and the like) may interact through text chat, and Voice over Internet Protocol (VOIP) exchange with other customers who are playing games on the game boxes through a system in accordance with an embodiment of the invention. Further, the one or more customers may also play games on their mobile phones with each other.

In an embodiment of the invention, at step 118, the one or more functions are performed in response to inputs received from the one or more customers through their mobile phones and the reward points associated with the one or more functions or with the inputs of the one or more customers are also determined. In an embodiment of the invention, the reward points may be pre-defined. In another embodiment of the invention, the reward points may be calculated using a reward and transaction system called ‘Bucket’. The ‘Bucket’ includes records indicating the movies, music, photos and other data uploaded by and downloaded by the customer, and the credits, payments rewards and transactions associated with each and with the available barter, transfers and trade with other members of the network. At any point of time the one or more customers may check their reward points. The one or more customers may exchange their reward points with other offers. The ‘Bucket’ provides a common transaction center for activities across all social networks and payment systems such as PayPal™, MotoPoints™ provided by the system, and credits of music, movies, VOIP, text messages, wireless minutes and other gifts.

In an embodiment of the invention, a location based advertising facility and location based incentives may be performed by using a Cellular Coupon Engine. The Cellular Coupon Engine is a database of client promotional incentives which are cross referenced to current customer location, interest, profile and other data in order to massively execute targeted promotions to specific customers.

The reward system is explained in details in conjunction with the following example. Mr. Mike is walking down Market Street and approaching Stockton. His web-enabled mobile phone beeps and he opens it to view the cover of a new audio CD (Compact Disc) album from one of his favorite Brazilian bands, Guinea. A colorful message from Virgin Records across the street scrolls across the screen which says “Welcome to the neighborhood! Stop in and pick up this CD to avail 20% off. Send this message to 5 friends right now to avail another 10% off and two of your favorite songs for free! See you in 15 minutes for 50 reward points”.

It will be appreciated that the order of steps in FIG. 1 may vary in various embodiments of the invention.

The method described above includes different steps involved in managing the multi-function social network. The method may include a greater or a fewer number of steps than those included in FIG. 1.

In an embodiment of the invention, the method described in FIG. 1 may be implemented using a computer program product. Examples of the computer program product include but are not limited to memory devices, tapes, disks, cassettes, integrated circuits, servers, online software, download links, installation links, and online links.

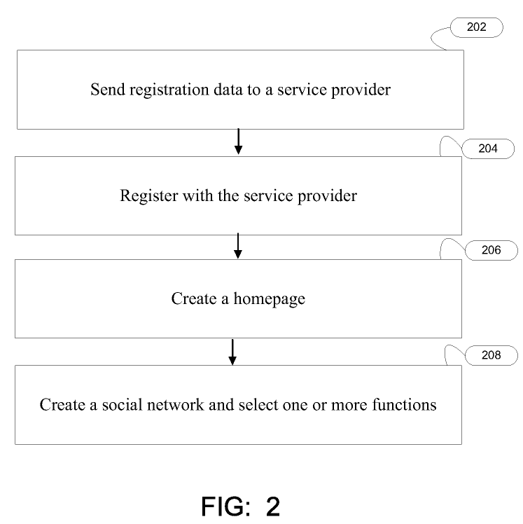

FIG. 2 is a flowchart illustrating a method for managing a multi-function social network by one or more customers in accordance with an embodiment of the invention. At step 202, registration data is sent to the service provider through the one or more mobile phones.

At step 204, the customers are registered with the service provider using a unique identification key. In an embodiment of the invention, the unique identification key is a multidisciplinary algorithm. It uses the logic that the customer's phone number is already registered and attached to the mobile phone and, for example, the customer's name initials to the front of phone number can create a unique identification key.

At step 206, a homepage for each customer is created in the service provider's database. In an embodiment of the invention, the homepage may be created using the nine keys of the mobile phone and is termed as ‘9-build’. This feature uses the keys on each phone, numbered one through 9, to execute pre-built macros on the service provider's servers, which the keys act as shortcuts for command-line website construction application sets. Facilities such as auto fill up and the like are enabled, and pre-created templates are associated with each number key on the dial pad of the mobile phone.

At step 208, the social network is created and the customers select one or more functions displayed on their mobile phones. In an embodiment of the invention, the customers login to their homepages through the mobile phone using a unique identification key. After logging in to the homepages, the customers may perform a set of functions through single key stokes in the mobile phone. Pre-created templates are tied to each of the nine numeric keys of the telephone keypad for a land phone or cell phone. A logical flowchart of implementation options follows each of 9 choices, for example 1 for movies, 2-music, 3-voice notes, 4-Wall papers, 5-Multimedia messages, 6-Ring tones, 7-Voicemail customizations, 8-photos, and 9-Special media. In special media key there will be sub menu keys, for example, 1-create, 2-find, 3-open, 4-edit, 5-tools, 6-delete, 7-send, 8-attend and 9-help. Customers may also share data files in real time, for example, a live sound and music, a live concert or a live party. The data files include personal data for personalizing the experiences.

The method described above includes different steps involved in managing the multi-function social network. The method may include a greater or a fewer number of steps than those included in FIG. 2.

In an embodiment of the invention, the method described in FIG. 2 may be implemented using a computer program product. Examples of the computer program product include but are not limited to memory devices, tapes, disks, cassettes, integrated circuits, servers, online software, download links, installation links, and online links.

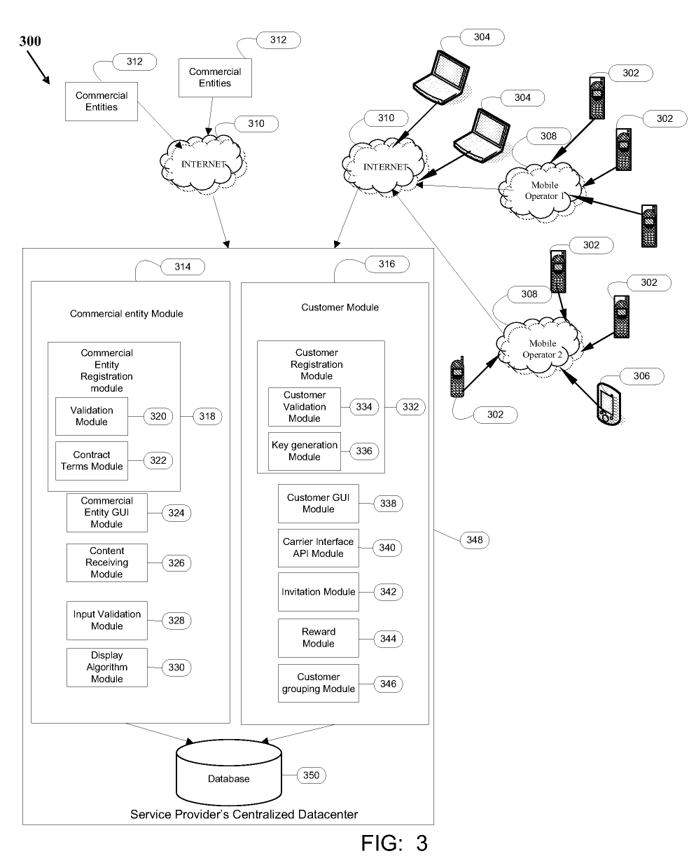

FIG. 3 is a schematic representation of a system 300 in accordance with an embodiment of the invention. The system 300 includes one or more customers communicating through web enabled mobile phones 302, personal computers 304, and Personal Digital Assistants (PDAs) 306 to a centralized data center 348 provided by the service provider, and one or more commercial entities 312 registered with the centralized data centre 348. The users of mobile phones 302 and PDAs 306 are associated with their respective mobile network providers 308. The mobile network operators 308 communicate to the centralized data centre 348 through internet 310.

The service provider's centralized datacenter 348 includes a customer module 316 and a commercial entity module 314. The customer module 316 enables communication among the one or more customers and the service provider. The commercial entity module 314 enables communication between the one or more commercial entities 312 and the service provider. In an embodiment of the invention, the commercial entity module 314 may enable communication between the one or more commercial entities 312 and the one or more customers. The customer module 316 includes a customer registration module 332 for registering the one or more customers with the service provider. The customer registration module 332 receives the registration data from the one or more customers and validates the registration data using a customer validation module 334. The key generation module 336 generates a unique identification key for each of the customers and the one or more customers use this key for registration and further logging into the homepage. The customer Graphical User Interface (GUI) module 338 provides an interactive communication between customer's mobile phones 302 and the service provider.

Application Program Interface (API) module 340 provides a platform to the one or more commercial entities 312 to advertise on the customer's mobile phones 302, personal computers 304, and PDAs 306 independent of the communication network providers, communication protocol and types of the devices. The software operated by the service provider contains the logic to convert standard format to the network carrier specific format and vice versa. The customer grouping module 346 groups the one or more customers into one or more communities based on the registration data, activities of the one or more customers in the multi-function social network. Customers perform a set of functions through the mobile phones 302 and interact with each other in the multi-function social network. Through the invitation module 342 customers communicate with each other, for example, they invite other customers to join the multi-function social network. The reward module 344 determines the reward points for each of the customers based on the one or more functions selected and performed. The reward points are automatically updated in the customer accounts.

The one or more commercial entities 312 communicate to the centralized datacenter 348 and the commercial entity module 314 enables communication between the one or more commercial entities and the service provider. The commercial entity registration module 318 registers the one or more commercial entities with the service provider. The commercial entity registration module 318 includes a validation module 320 and a contract module 322. The validation module 320 filters the one or more commercial entities 312 based on a set of pre-defined conditions. In an embodiment of the invention, the pre-defined conditions may include type of commercial entity, for example, pornographic commercial entities may not be allowed. The contract module 322 defines the service contract between the commercial entity and the service provider. In an embodiment of the invention, the contract module 322 stores the service contract between the commercial entity and the service provider.

The commercial entity GUI module 324 enables the communication between one or more commercial entities 312 and the service provider. After validation and registration the data file module 326 uploads the data files from the one or more commercial entities 312 and the input validation module 328 validates the advertising contents. The permissible advertising contents according to the service contract with the service provider are stored in the data file module 326. The commercial entities 312 may want to display the advertising contents to a specific group of target customers in the multi-function social network. Using the display module 330 the advertising contents are displayed to the set of selected target customers.

In an embodiment of the invention system 300 is a multi-function social networking system.

System 300 described above may include a greater or a fewer number of modules than those included in FIG. 3.

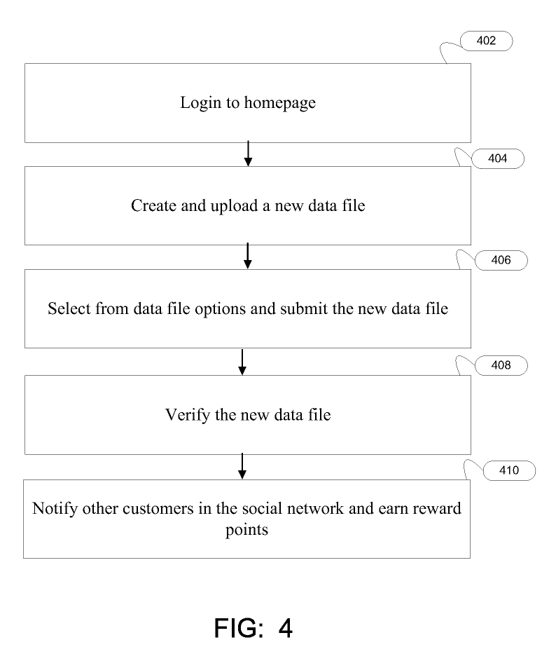

FIG. 4 is a flowchart illustrating a method for uploading data files in a multi-function social network by one or more customers in accordance with an embodiment of the invention. At step 402 the one or more customers login to their homepage. The one or more customers log into their respective homepages using the unique identification key.

At step 404, a new data file is created and uploaded in the database of the service provider by the one or more customers. Examples of the data files include but are not limited to video files, photos, and audio files. The data files may be transmitted using various delivery protocols including WAP and Java protocol, customer's voicemail, SMS, and Hypertext Transfer Protocol (HTTP) depending on the data file content.

In an embodiment of the invention, the data files may be uploaded using the web enabled mobile phone and using single key strokes.

At step 406, one of the data file submit options is selected and the new data file is submitted. At step 408, the data file is verified and made available for downloading.

At step 410, the customer who uploaded the new data file notifies other customers in the multi-function social network and earns reward points. In an embodiment of the invention, the customer may also update an existing data file and notify other customers.

The method described above includes different steps involved in uploading data files in a multi-function social network. The method may include a greater or a fewer number of steps than those included in FIG. 4.

In an embodiment of the invention, the method described in FIG. 4 may be implemented using a computer program product. Examples of the computer program product include but are not limited to memory devices, tapes, disks, cassettes, integrated circuits, servers, online software, download links, installation links, and online links.

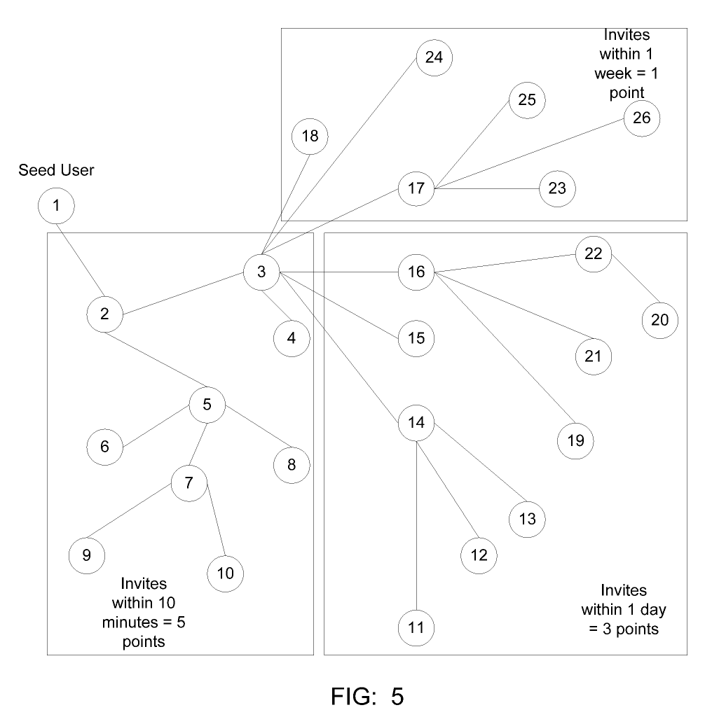

FIG. 5 is an exemplary graphical representation of a multi-function social network centered on a customer numbered as ‘1’, hereinafter referred to as cutomer-1, in accordance with an embodiment of the invention. Other members of this multi-function social network include customers numbered from 2 to 26. The customer-1 invites customer-2 in ten minutes and gets ‘5’ reward points. The customer-1 invites customer-3 and customer-5 from customer-2's network. As an example, the customer-1 gets ‘5’ reward points for every customer invited within ten minutes, ‘3’ reward points for every customer invited within one day, and ‘1’ reward point for every customer invited within one week. In an embodiment of the invention, a pre-architected rapid deployment customer backend may be used.

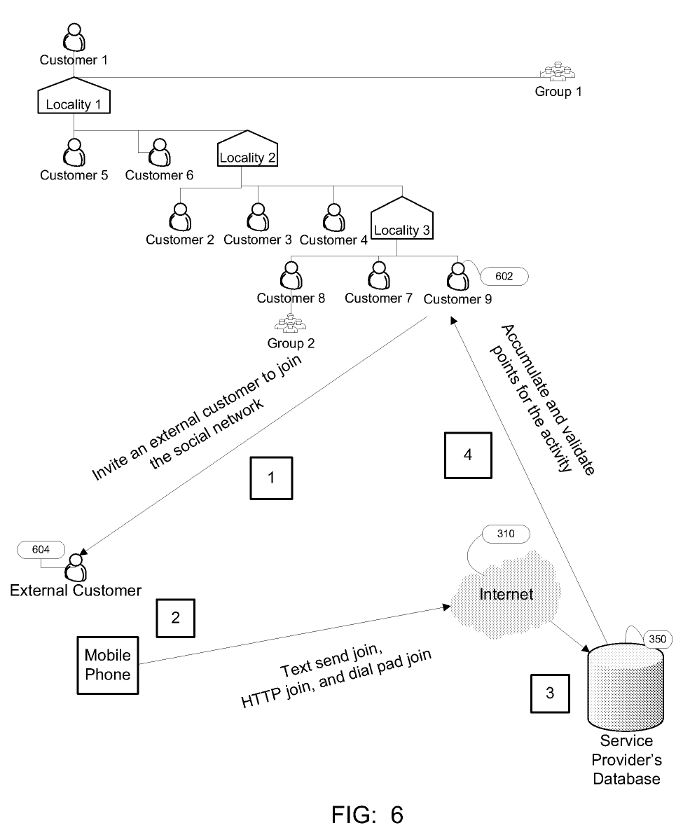

FIG. 6 is an exemplary representation illustrating a method for joining a multi-function social network by a customer in accordance with an embodiment of the invention. A customer 602 invites an external customer 604 to join the multi-function social network. In an embodiment of the invention, the external customer 604 may be notified by sending an invitation to a mobile phone of the external customer 604. The external customer 604 accepts the invitation and joins the multi-function social network by registering with the service provider's database 350. The external customer 604 may register to the service provider's database 350 by sending text, HTTP join, dial pad join and the like.

The method described above includes different steps involved in joining the multi-function social network. The method may include a greater or a fewer number of steps than those included in FIG. 6.

In an embodiment of the invention, the method described in FIG. 6 may be implemented using a computer program product. Examples of the computer program product include but are not limited to memory devices, tapes, disks, cassettes, integrated circuits, servers, online software, download links, installation links, and online links.

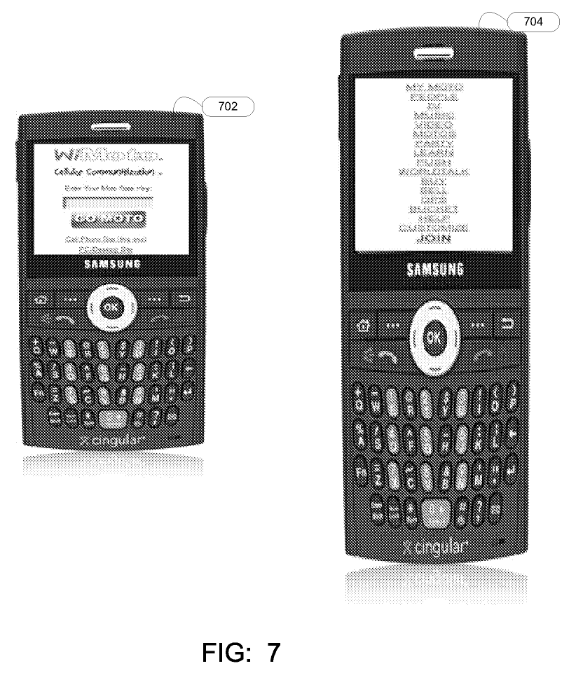

FIG. 7 is an exemplary Graphical User Interface (GUI) in accordance with an embodiment of the invention. FIG. 7 includes a welcome screen 702 on the mobile phone where the customer enters the unique identification key to log in (shown as ‘Moto Key’ in FIG. 7, 702). The screen 704 shows the different menu options available to the customers. The different menu options include people, TV, music, party, learn, world talk, buy, sell, bucket, customize and join.

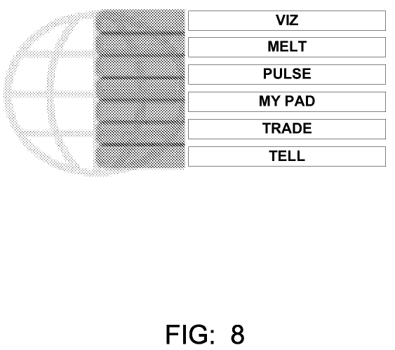

FIG. 8 is an exemplary Graphical User Interface (GUI) in accordance with another embodiment of the invention.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A method comprising:
locating one or more communication devices;
capturing activities on the one or more communication devices; and
providing data files to the one or more communication devices independent of types of the one or more communication devices, communication protocol and communication network providers associated with the one or more communication devices, wherein the data files are provided based on the activities.

2. The method of claim 1, wherein locating comprises using global location resource.

3. The method of claim 1, wherein providing data files comprises displaying one or more functions on the one or more communication devices.

4. The method of claim 3 further comprising performing the one or more functions in response to inputs received from the one or more communication devices.

5. The method of claim 4 further comprising providing reward points based on the inputs.

6. The method of claim 1 further comprising uploading the data files.

7. The method of claim 1, wherein the data files are provided through a mobile virtual network operator.

8. The method of claim 1 further comprising registering one or more entities.

9. The method of claim 7, wherein registering comprises at least one of:
storing registration data in a database;
validating the registration data; and
defining contracts;
based on the one or more entities.

10. The method of claim 1 further comprising creating one or more homepages.

11. The method of claim 1 further comprising enabling communication among one or more entities and a service provider.

12. The method of claim 1 further comprising grouping one or more entities.

13. The method of claim 1 further comprising combining one or more online social networks.

14. A method comprising;
registering one or more commercial entities;
uploading data files from the one or more commercial entities;
enabling communication between a service provider and the one or more commercial entities; and
providing the data files independent of communication protocol and communication network provider.

15. A method comprising:
registering one or more customers;
creating one or more homepages for the one or more customers;
grouping the one or more customers based on a pre-determined criteria;
providing one or more functions to the one or more customers;
performing the one or more functions in response to the inputs received from the one or more customers in real time; and
providing reward points based on the inputs.

16. A system comprising:
a database;
a customer module, the customer module enabling communication among one or more customers and a service provider; and
a commercial entity module, the commercial entity module enabling communication between one or more commercial entities and the service provider.

17. The system of claim 16, wherein the customer module comprises:
a customer registration module, the customer registration module registering the one or more customers;
a customer graphical user interface module, the customer graphical user interface module enabling communication between the one or more customers and the service provider;
an application program interface module, the application program interface module providing a platform to one or more commercial entities to advertise on one or more communication devices associated with the one or more customers independent of types of the one or more communication devices, communication protocol and communication network providers associated with the one or more communication devices;
an invitation module, the invitation module enabling communication among the one or more customers;
a reward module, the reward module determining reward points for the one or more customers based on one or more functions selected by the one or more customers; and
a customer grouping module, the customer grouping module grouping the one or more customers into one or more communities based on registration data and activities of the one or more customers.

18. The system of claim 17, wherein the customer registration module comprises:
a customer validation module, the customer validation module validating the registration data of the one or more customers;
a key generation module, the key generation module generating a unique identification key for the one or more customers.

19. The system of claim 16, wherein the commercial entity module comprises:
a commercial entity registration module, the commercial entity registration module registering the one or more commercial entities;
a commercial entity graphical user interface module, the commercial entity graphical user interface module enabling communication between the one or more commercial entities and the service provider;
a data file module, the data file module uploading data files from the one or more commercial entities; and
a display module, the display module displaying the data files to the one or more customers.

20. The system of claim 19, wherein the commercial entity module further comprises a validation module, the validation module validating the data files.

21. The system of claim 19, wherein the commercial entity registration module comprises:
an input validation module, the input validation module filtering the one or more commercial entities based on a set of pre-defined conditions; and
a contract module, the contract module determining contract between the one or more commercial entities and the service provider.

22. A computer program product for use with a computer, the computer program product comprising a computer readable program code for managing a multi-function social network, the computer readable program code performing:
locating one or more communication devices;
capturing activities on the one or more communication devices; and
providing data files to the one or more communication devices independent of types of the one or more communication devices, communication protocol and communication network providers associated with the one or more communication devices, wherein the data files are provided based on the activities.

23. The computer program product of claim 22, wherein the computer readable program code further performs one or more functions in response to inputs received from the one or more communication devices.

24. The computer program product of claim 23, wherein the computer readable program code for performing the one or more functions further performs determining reward points based on the inputs.

25. The computer program product of claim 22, wherein the computer readable program code further performs registering one or more entities.

26. The computer program product of claim 24, wherein the computer readable program code for performing the registering further performs at least one of:
storing registration data in a database;
validating the registration data; and
defining contracts;
based on the one or more entities.

27. The computer program product of claim 22, wherein the computer readable program code further performs creating one or more homepages.

28. The computer program product of claim 22, wherein the computer readable program code further performs enabling communication among one or more entities and a service provider.

29. The computer program product of claim 22, wherein the computer readable program code further performs grouping one or more entities.

30. The computer program product of claim 22, wherein the computer readable program code further performs combining one or more online social networks.

31. The computer program product of claim 22, wherein the computer readable program code further performs uploading the data files.
